(19) United States
(12) Patent Application Publication
(10) Pub. No.: US 2008/0147423 A1
(43) Pub. Date: Jun. 19, 2008

(54) Method and system for confirming/verifying receipt of a mailpiece using radio frequency identification (RFID)

(76) Inventors: John F. Braun, Fairfield, CT (US); Ronald Reichman, Trumbull, CT (US); Pradeep K. Das, Bethel, CT (US); Andrei Obrea, Seymour, CT (US); Theresa Biasi, Shelton, CT (US); John W. Sussmeier, Cold Spring, NY (US); Tim Walsh, London (GB); Leon Pintsov, West Hartford, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/642,008

(22) Filed: Dec. 19, 2006

(51) Int. Cl. G06Q 50/00

(52) U.S. Cl. 705/1

(57) ABSTRACT

A method and system is provided for confirming and/or verifying receipt of a mailpiece by an intended mail recipient. The method includes the step of establishing a relationship between the intended mail recipient and an RFID tag affixed to the mailpiece. Upon delivery of the mailpiece, the actual mail recipient is caused to affect communication between an RFID enabled phone in the possession of the actual mail recipient and the RFID tag of the mailpiece. By comparing the information acquired by the RFID enabled phone and the RFID tag, (i.e., the relationship information stored on the RFID tag), a determination can be made as to whether the intended mail recipient is the actual mail recipient. Alternate embodiments of the invention effect confirmation/verification by capturing various biometric characteristics of the mail recipient and comparing such information to previously stored biometric data of the intended mail recipient.

### FIELD OF THE INVENTION

The present invention relates to a verification method and system to confirm receipt of a mailpiece by its intended mail recipient and, more particularly, to a method and system which employs Radio Frequency Identification (RFID) technology to establish timely and reliable recipient verification.

### BACKGROUND OF THE INVENTION

Radio Frequency IDentification (RFID) is a method of identifying unique information and/or devices using radio waves. Typically, a reader communicates with an RFID tag/device which holds unique digital information in an embedded microchip/processor. The tag/device typically employs a receiving antenna which acquires energy from an external energy source to power the microchip/processor. The tag/device may then transmit information to the interrogating reader or communicate with other tags/devices within a defined field or zone.

More specifically, RFID systems can be passive, active or semi-passive. A passive RFID system employs a passive tag/device having a receiving antenna which is sufficiently large, or selectively shaped/dimensioned, to capture (or harvest) energy from a surrounding electromagnetic field, i.e., the radio frequency energy, to power the passive tag/device. The receiving antenna is electrically connected to the central microchip/processor to perform various preprogrammed functions. An active RFID system employs an active tag/device having an energy source, e.g., an embedded battery, to power the active device and broadcast signals to the reader. Consequently, active RFID systems do not require an electromagnetic field to power the tag/device. A semi-passive system is similar to active systems in the sense that an energy source is employed to power a tag/device, however, the energy is used to activate or augment the microchip's processing capability rather than to broadcast signals back to the reader. The tags/device employed in semi-passive systems are also referred to as battery-assisted tags inasmuch as a portion of the energy is acquired from the tag while another portion is obtained from the read field of the antenna. As such, semi-passive tags can increase the read range of the RFID system.

RFID systems facilitate tracking of various items (i.e., items which have an accompanying RFID tag/device) for the purpose of controlling merchandise, maintaining inventory levels, or monitoring the location and/or flow of important documents. At present, however, RFID tags are principally used in the retail and distribution industries as a preferred means for controlling and maintaining high value inventory such as electronic equipment, home appliances, etc. While the cost to implement such RFID tags/devices has diminished dramatically with increased use, the cost of such RFID systems continues to prohibit their widespread use in lower value retail/industrial items.

Another technology to which the current invention is directed relates to methods for verifying whether an item, e.g., a parcel, package or mailpiece has been properly or timely delivered to a mail recipient. Generally, verification methods have been limited to several low-cost techniques which can be highly unreliable and/or imprecise. For example, a signed “return receipt” only ensures that a mailpiece has been received by a person residing, or located, at the destination address at the time of delivery. While such methods may ensure that the mailpiece has not been inadvertently misplaced, it does little to verify that the intended and actual recipients are one and the same. Further, while it is possible to subsequently perform a forensic signature analysis, such methods fail to ensure that the mailpiece has reached its intended recipient.

Other methods of verification may involve the electronic scanning of a barcode symbology known to be located at a particular destination. That is, a delivery agent may be required to scan the barcode upon reaching the destination. As such, electronic scanning can minimally verify that the delivery agent arrived at the location at a particular time. To the extent that the delivery agent has arrived at the destination address and is not motivated by other considerations (e.g., mail theft/fraud), it is reasonable to conclude that the mailpiece was delivered.

In view of the foregoing, a need exists for a verification method and system to confirm receipt of a mailpiece by its intended mail recipient and to a method which employs Radio Frequency Identification (RFID) technology to establish timely and reliable recipient verification.

### SUMMARY OF THE INVENTION

A method and system is provided for confirming and/or verifying receipt of a mailpiece by an intended mail recipient. The method includes the step of establishing a relationship between the intended mail recipient and an RFID tag affixed to the mailpiece. Upon delivery of the mailpiece, the actual mail recipient is caused to affect communication between an RFID enabled phone in the possession of the actual mail recipient and the RFID tag of the mailpiece. By comparing the information acquired by the RFID enabled phone and the RFID tag, (i.e., the relationship information stored on the RFID tag), a determination can be made as to whether the intended mail recipient is the actual mail recipient. Alternate embodiments of the invention effect confirmation/verification by capturing various biometric characteristics of the mail recipient and comparing such information to previously stored biometric data of the intended mail recipient.

### BRIEF DESCRIPTION OF THE DRAWINGS

Reference is now made to the various figures wherein like reference numerals designate similar items in the various figures and in which:

FIG. 1 is schematic view of a Radio Frequency IDentification (RFID) enabled phone in near field communication with an RFID tag.

FIG. 2 is a diagram pictorially illustrating the relationship of the participants and entities involved in practicing an inventive method for confirming and/or verifying delivery of a mailpiece to its intended recipient.

FIG. 3 is a flowchart of the method according to the teachings of the present invention.

FIG. 4 is a pictorial illustration of the various system elements/components employed for practicing the inventive method including a computer database containing certain mailpiece data, a mailpiece having a Radio Frequency IDentification (RFID) tag/device affixed thereto, and a processor/wireless communication device for establishing a relationship between the RFID tag/device and the computer database.

FIG. 5 is a pictorial illustration of the system elements/components depicted in FIG. 4 including an RFID-enabled telephone confirming/verifying delivery of the mailpiece to an intended mail recipient.

### DETAILED DESCRIPTION OF THE INVENTION

The present invention describes a method and system for confirming and/or verifying the delivery of a mailpiece to an intended recipient. In the context used herein the term “mailpiece” means any article including a letter, parcel, brochure, newspaper, magazine, mail unit or item which may be handled by a delivery agent such as the United States Postal Service (USPS), United Parcel Service (UPS), and Federal Express (FEDEX) etc. for delivery to a mailpiece recipient. A “mail unit” is any mailpiece or group of mailpieces which are physically constrained or bound together such as a bundle of newspapers or magazines.

Generally, the sender of a mailpiece may have a desire to know that a mailpiece has been delivered to a particular recipient. It may not be sufficient, as may be the case when delivering an important document such as a legal notice, to rely upon a signature to authenticate its delivery. As discussed in the background, the prior art methods of delivery confirmation generally rely upon evidence that the mailpiece has reached a destination and/or has been received by an individual residing, or at least located, at the intended destination. The actual mail recipient may or may not be the intended recipient, and a signature obtained may or may not be authentic. It will be appreciated therefore that important documents and/or parcels containing high value articles (which are becoming more frequent with the increased volume of internet commerce and mail order shipping) will require more reliable/accurate forms of confirmation/verification.

The method and system of the present invention is capable of inquiring and responding to the fundamental tenants/questions of a robust verification security system. That is, the method and system can confirm an individual's identity by authenticating answers to the following: “What I am”, “What I know”, and “What I have”. The various methods to authentic a recipient's identity will become apparent in light of the subsequent detailed description of the inventive method/system.

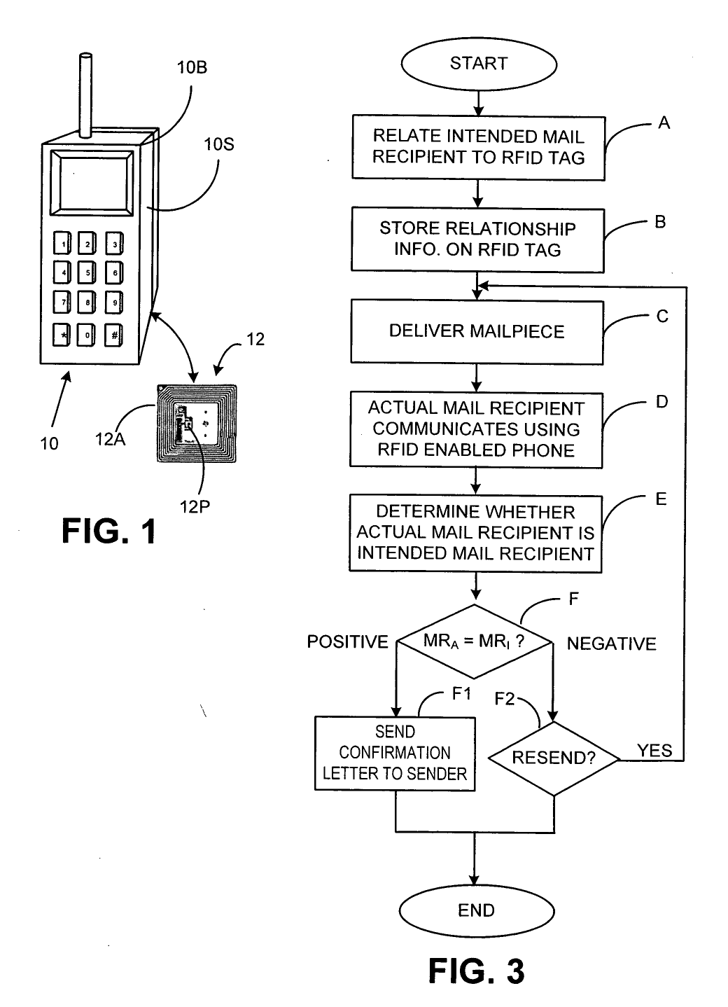

Before discussing the method steps in detail, it will be useful to describe some of the system elements used in the practice of the inventive method. One such system element, shown in FIG. 1, is a Radio Frequency Identification (RFID) enabled cellular phone 10. Such RFID-enabled phones 10 generally include a detachable shell 10S which is in communication with the base phone 10B and which communicates with RFID tags/devices 12. In the context used herein an “RFID enabled phone”, therefore, is any phone capable of contacting or communicating with an RFID tag, whether or not the communication link is housed within a detachable shell or is integrated internally of the cellular phone.

The RFID portion or shell 10S of the phone 10 operates in a manner very similar to readers employed in conventional RFID systems. That is, the RFID shell 10S emits electromagnetic energy which is harvested by the antenna 12A of an RFID tag to energize the microchip/microprocessor 12P of the RFID tag 12. With the power acquired, the microchip 12P of the RFID tag 12 is capable of receiving and/or transmitting information (e.g., information stored or recorded by/in the microchip 12P) to or from the RFID-enabled phone 10. While the RFID-enabled phone 10 generally will communicate with a single RFID tag 12, it should be appreciated that the RFID phone 10 may communicate with multiple tags, though an anti-collision algorithm will be necessary to enable communications.

RFID-enabled phones of the type described, and those which are currently available, generally operate in the 13.56 MHz frequency range. Although, it will be appreciated that other operational frequencies can be used to energize an RFID tag. Furthermore, such phones operate using Near Field Communication (NFC) which is a function of the frequency range, and simply means that the shell 12 of the phone 10 must be in the proximity of the RFID tag 12 to establish and/or maintain communication, i.e., generally within a few centimeters. Consequently, communication therebetween will generally require that the phone 10 be waved or wand directly over the RFID tag 12. One such RFID-enabled phone which is commercially available is manufactured and sold by Nokia having a regional office in Irving, State of Texas and having its headquarters in the country of Finland. More specifically, the company offers a Nokia NFC Shell for use in connection with its Nokia 3220 cellular phone.

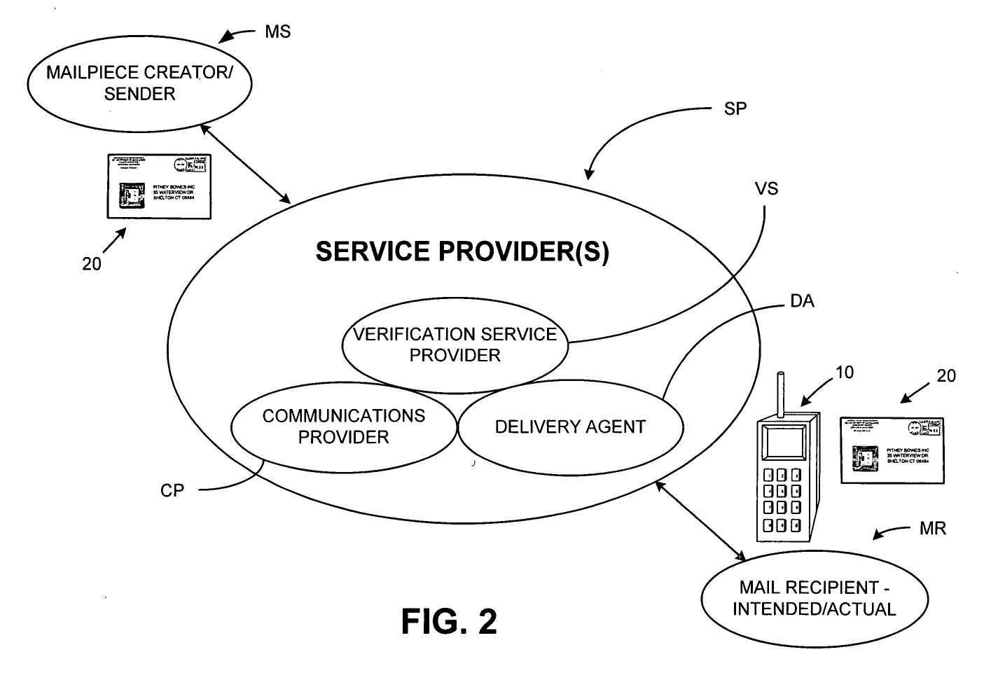

In FIG. 2, the method of the present invention may involve several individuals and/or entities to perform the various method steps including a Mailpiece Creator or Sender MS, a Mailpiece Recipient MR (intended/actual), a Verification/Notification Service Provider VS, a Communications Service Provider CP, and a Delivery Service or Agent DA. Though it will be appreciated that any one of the Service Providers or Agents VS, CP, DA can provide one or all of the services. Accordingly, the method will generally require actions from a Mailpiece Sender MS, a Mailpiece Recipient MR and a Service Provider SP, i.e., providing verification, delivery and/or communications services.

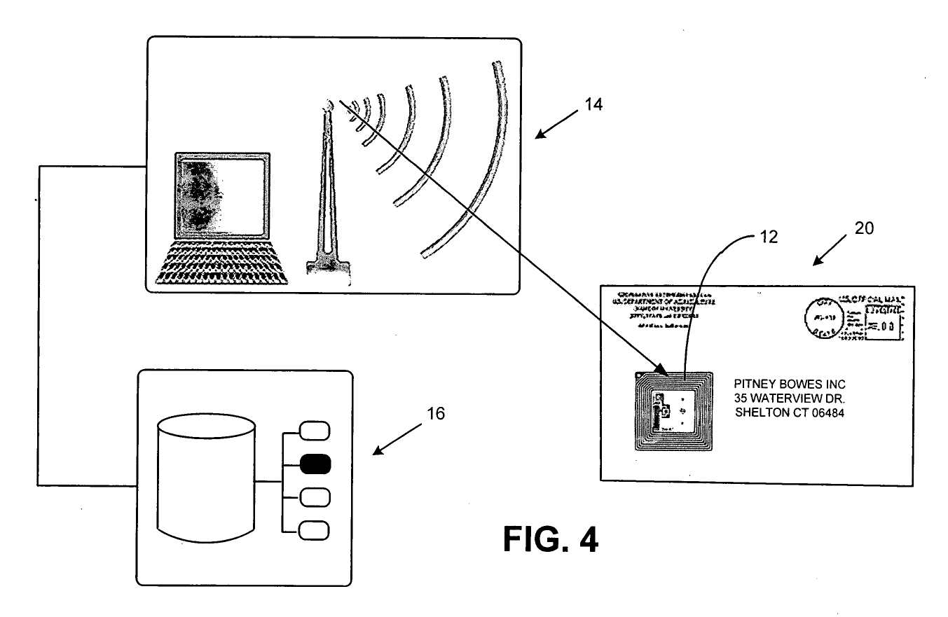

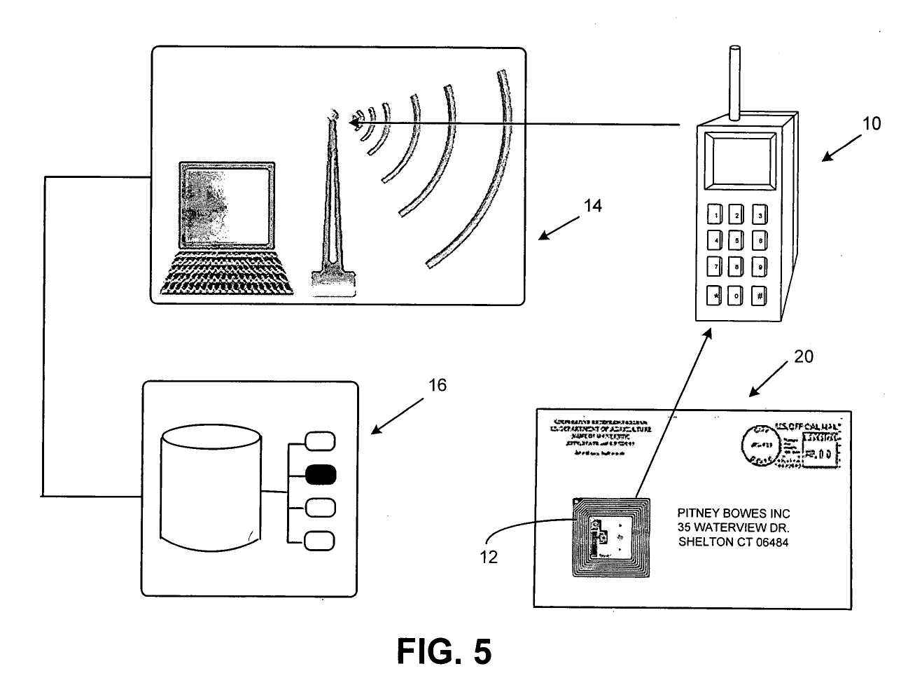

In FIG. 3, a flowchart depicts a combination of method steps useful for confirming/verifying that a mailpiece has received its intended recipient while FIGS. 4 and 5 pictorially illustrate the system elements used to practice the inventive method. A first Step A establishes a relationship between an intended mail recipient and an RFID tag 12 (see FIG. 2). In the context used herein “establishing a relationship” means that an RFID reader 14 or other similar device reads the unique identification number of the RFID tag 12 and relates the ID number to other information, typically contained in a computer database 14, specific to the intended mail recipient such as name and address information.

More specifically, in FIGS. 2-5, the Mailpiece Sender/Creator MS may send a mailpiece to the Service Provider SP indicating that they wish to verify/confirm that a mailpiece 20 has been delivered to the correct mailpiece recipient, i.e., the intended mailpiece recipient MR. The Sender MS may elect only one or several verification measures relating to those discussed previously, i.e., “what I have”, “what I know” and “what I am”. For the purposes of setting forth an example, an assumption will be made that the Sender MS elects/requests the highest level of verification available, i.e., requiring confirmation of the intended Mailpiece Recipient MR at all levels. Depending upon the communication links established, the Sender MS can maintain the database 14 (see FIG. 4) of recipient data (the intended Recipients Name and Address) or rely upon the Service Provider SP to maintain all necessary mailing and verification information.

To respond to the Sender's request, the Service Provider SP will need to collect a significant amount of verification data and, for the purposes of the exemplary embodiment discussed herein, it is assumed that all such data can be acquired/obtained via public and personal records. For example, the Service Provider SP may establish a database 14 having the following information/fields: the ID or serial number of the RFID tag, Name and Address of the Intended Mail Recipient MR, RFID enabled phone number of the intended Mail Recipient MR, Mail Recipient personal identification number (PIN) or social security number (SSN) and various Biometric Characteristic data of the Mail Recipient. With respect to the latter, the Biometric Characteristic data may include the voice print signature, fingerprint, iris or retinal scan data of the intended Mail Recipient.

In Step B, the RFID tag 12 is activated/read to store the serial number or ID in the computer database 14. At this time, the RFID tag may or may not be affixed to the mailpiece 20, though the RFID tag is necessarily inserted within, attached or affixed to, the mailpiece 20 prior to its delivery in Step C. In the case of a mail unit, the RFID tag may be attached to only one of the mailpieces/items contained therein, or be affixed to the package which binds or contains the individual mail pieces/items.

In step D, the mailpiece is opened and read by the actual Mail Recipient MR_{A}. The recipient is referred to as the “actual” Mail Recipient MR_{A} inasmuch as it has not, as yet, been determined that the actual Mail Recipient MR_{A} and intended Mail Recipient MR_{I} are one and the same. Instructions may be provided to the actual Mail Recipient MR_{A} to waive or wand his/her RFID enabled phone 10 over or in close proximity to the RFID tag 12 (best seen in FIG. 5). To establish communication with the communication network or provider CP, the actual Mail Recipient may be asked to call a number, press the pound (#) key or other instruction.

Upon taking this active step, the Service Provider SP can now ascertain in Step E, whether the actual Mail Recipient MR_{A} and intended Mail Recipient MR_{I} are the same. While this step satisfies the portion of security which asks “what I have” or “Do I have or am I operating a cell phone registered to the intended Mail Recipient?”, other tests or conditions may be satisfied to obtain higher levels of confirmation. For example, the actual Mail Recipient can be asked to capture a picture, via a cell phone digital camera or optical imaging system, of the mailpiece in his/her possession. The image can be mailed back to the Service Provider for confirmation.

With respect to questions of “what I know”, the Service Provider can require the RFID-enabled cell phone operator to input a personal identification number (PIN), his/her social security number (SSN) or other information which may only be known to the cell phone operator. As such, in addition to obtaining an acknowledgement from a Communications Provider CP that the person operating the RFID enabled phone 10 is registered to an individual having the same name as the intended Mail Recipient MR_{I}, a further confirmation is now provided by comparing personal identification numbers (PINs) or the social security number (SSN) to the characteristic data on file in the database 12.

With respect to the questions concerning “what I am”, the Service Provider can ask the RFID-enabled cell phone operator (still referred to as the actual Mail Recipient MR_{A}) to capture certain of his/her biometric characteristics for comparison to biometric data which is on file in the database 12. For example, actual Mail Recipient MR_{A} may be asked to capture a facial image of him/herself for subsequent comparison purposes. Inasmuch as cell phones are becoming more sophisticated and can incorporate high resolution devices, it is well-within the skill of those in the art to incorporate a digital scanning device on the face of the cell phone to capture biometric data such as fingerprints or a scan of the operator's iris or retina. Of course, having this information on file in the database 12 may be more difficult to obtain. It will be appreciated, however, that such biometric data will be more available as such identification methods become more widespread in terms of there use. Inasmuch as a cell-phone includes a microphone, it is also well-within the skill of the art to obtain a voiceprint signature of the operator to be compared to a voice signature stored in the database 12. In this embodiment, voice recognition software can be used to ascertain whether the actual Mail Recipient MR_{A} and intended Mail Recipient MR_{I} are one and the same.

If, in step F, it is determined that the actual Mail Recipient MR_{A} and intended Mail Recipient MR_{I} are the same, then a message may be sent to the Mailpiece Sender MS in step F1 that a “positive” verification/confirmation has been obtained. If no verification/confirmation can be achieved or a “negative” result is obtained, then the Mailpiece Sender may be asked, in step F2, whether the mailpiece 20 should be resent in an effort to locate the intended Mail Recipient MR_{I}.

While the invention has described a variety of methods to verify/confirm an operator's identity, it will be appreciated that a mailer may opt for one or a combination of verification techniques depending upon the confidence level he/she wishes to achieve. For example, a mail sender may opt to require one of each security measures e.g., request a PIN, a picture of the mailpiece and a picture of the mail recipient, to achieve a certain confidence level.

In summary, the present invention provides a method and system for confirming/verifying that a mailpiece has been sent to and received by its intended recipient. The invention employs a combination of presently and/or recently developed systems, e.g., RFID technology including RFID enabled phones, relational databases, digital scanning devices, imaging systems, wireless/optic communications networks/links, and Global Positioning Systems (GPS), to more accurately and reliably ensure delivery of a mailpiece. Inasmuch as the implementation of such confirmation/verification methodology would greatly increase the quantity of RFID tags manufactured and used, it is anticipated that the per unit cost of such RFID tags would decrease substantially, e.g., from twenty-five/thirty cents ($0.25/$0.30) per tag to perhaps two to three cents ($0.02/$0.03) for each tag. Consequently, the cost of an RFID tag in combination with a mailpiece will not unduly burden the cost of delivery and present a significant obstacle or deterrent to the implementation of such confirmation/verification process. Moreover, it is further anticipated that the quality and resolution of various sensing devices disposed in combination with cellular phones will continue to improve.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method for confirming and/or verifying receipt of a mailpiece by an intended mail recipient, the mail recipient in possession of a Radio Frequency IDentification (RFID) enabled phone operative to read an RFID tag, comprising the steps of:
establishing a relationship between an intended mail recipient and an RFID tag affixed to the mailpiece,
storing the relationship information on the RFID tag;
delivering the mailpiece;
having an actual mail recipient effect communication between the RFID enabled phone and the RFID tag of the mailpiece; and
determining whether the intended mail recipient is the actual mail recipient by evaluating information acquired from the RFID enabled phone and the RFID tag.

2. The method according to claim 1 wherein the step of establishing a relationship includes the step of:
associating the RFID tag with the mail recipient to create relationship information therebetween and
storing the relationship information in a database residing in a processor.

3. The method according to claim 2 wherein the step of effecting communication includes the steps of:
instructing the mail recipient to place the RFID enabled phone in close proximity to the RFID tag of the mailpiece,
placing the RFID enabled phone in close proximity to the mailpiece RFID tag;
establishing communication between the RFID enabled phone and the processor containing the relational database to compare the ownership information of the phone with the relationship information contained on the RFID tag.

4. The method according to claim 2 wherein the step of determining whether the intended mail recipient corresponds to the actual mail recipient further includes the step of
querying the relational database to determine whether the mailpiece containing the RFID tag is in near field communication with the RFID enabled phone.

5. The method according to claim 1 further comprising the step of:
sending a message to the sender of the mailpiece that the mailpiece has reached the intended mail recipient when it has been determined that the actual mail recipient is the intended mail recipient.

6. The method according to claim 1 wherein the RFID enabled phone includes an imaging device, and further comprising the step of:
imaging the mailpiece to acquire digital image information thereof; and
confirming receipt of the mailpiece by the intended mail recipient.

7. The method according to claim 6 wherein the imaging device is one of an optical and digital camera.

8. The method according to claim 6 wherein the imaging device is a digital scanner.

9. The method according to claim 1 wherein the RFID enabled phone includes a biometric sensing device, and further comprising the step of
storing biometric data of the intended mail recipient in a database of a processor;
instructing the actual mail recipient to capture a biometric characteristic of the actual mail recipient;
sending biometric characteristic acquired by the RFID enabled phone to the processor, and
comparing the biometric characteristic with the biometric data stored in the processor to confirm that the RFID enabled phone is operated by the intended mail recipient.

10. The method according to claim 9 wherein the biometric characteristic is a facial image and wherein the sensing device is one of an optical and digital camera.

11. The method according to claim 9 wherein the biometric characteristic is a fingerprint image and wherein the sensing device is a fingerprint scanning device.

12. The method according to claim 9 wherein the biometric characteristic is a retinal image and wherein the sensing device is a retinal scanner.

13. The method according to claim 9 wherein the biometric characteristic is a voice signature and wherein the sensing device is a microphone.

14. A system for confirming and/or verifying that a mailpiece has been sent to an intended mail recipient, the mail recipient in possession of a Radio Frequency Identification (RFID) enabled phone operative to read an RFID tag, comprising:
an RFID tag affixed to a mailpiece, the RFID tag having a unique identifier related to the intended mail recipient of the mailpiece;
a processor operative to store the relationship between the RFID tag and the intended mailpiece recipient in a relational database, and
an RFID enabled phone operated by an actual mail recipient and operative to read the RFID tag, the RFID enabled phone establishing communication with the processor when in near field communication with the RFID tag and
wherein the processor is operative to compare information derived from the RFID enabled phone with the relationship information stored on the RFID tag to determine whether the RFID enabled phone of an actual mail recipient is being operated by the intended mail recipient.

15. The system according to claim 14 further comprising a communication means operative to send a message to the mailpiece sender confirming that the mailpiece has reached the intended mail recipient.

16. The system according to claim 14 wherein the RFID enabled phone includes an imaging device to acquire digital image information thereof; and wherein the processor is operative to compare the digital image information to previously stored mailpiece information to confirm receipt by the intended mail recipient.

17. The system according to claim 16 wherein the imaging device is one of an optical and digital camera.

18. The system according to claim 16 wherein the imaging device is a digital scanner.

19. The system according to claim 14 wherein the RFID enabled phone includes a biometric sensing device operative to capture a biometric characteristic of the actual mail recipient, wherein the processor includes stored biometric data of the intended mail recipient and is operative to compare the biometric characteristic biometric data to confirm that the RFID enabled phone is operated by the intended mail recipient.

20. The system according to claim 19 wherein the biometric characteristic information is a facial image and wherein the sensing device is one of an optical and digital camera.

21. The system according to claim 19 wherein the biometric characteristic is a fingerprint image and wherein the sensing device is a fingerprint scanning device.

22. The system according to claim 19 wherein the biometric characteristic is a retinal image and wherein the sensing device is a retinal scanner.

23. The system according to claim 19 wherein the biometric characteristic is a voice signature and wherein the sensing device is a microphone.
